(19) United States
(12) Patent Application Publication
(10) Pub. No.: US 2012/0111586 A1
(43) Pub. Date: May 10, 2012

(54) LEVERAGE DEVICE FOR HAND TOOLS

(76) Inventor: Kim S. Kimball, Murray, UT (US)

(21) Appl. No.: 13/281,423

(22) Filed: Oct. 25, 2011

Related U.S. Application Data
(60) Provisional application No. 61/456,461, filed on Nov. 8, 2010.

(51) Int. Cl. A01B 15/12

(52) U.S. Cl. 172/1; 172/356

(57) ABSTRACT

An outboard stabilizing system (OSS) includes a stabilizer bar with first and second outboard extensions each with a wheel mounted thereon; and a hand tool secured to the stabilizer bar, wherein a length of the two outboard extensions is determined based on the hand tool.

The present application claims priority to Provisional Application Ser. No. 61/456,461, filed Nov. 8, 2010, the contents of which are incorporated by reference.

### BACKGROUND OF THE INVENTION

The preferred embodiment relates generally to a leverage device for hand tools.

### DESCRIPTION OF PRIOR ART

There are many common tools and implements that are typically handled such as garden implements like rakes, hoes, and graders, construction implements such as screeds and push brooms, and household implements such as squeegees or brushes.

These implements usually use a pulling or pushing motion to operate. These tools when put to use all have a certain resistance based on the type of tool attached to its end. For example, the friction of the tines on a rake when being dragged over soil or a ground surface, provide fairly substantial resistance. A push broom drags thousands of bristles over a concrete floor and a hand grader drags its lateral blade atop soil also creating a fair amount of resistance. Hoes (Hula Hoe) used for upturning soil have tremendous friction depending on how far down they penetrate. Even a squeegee has resistance with its rubber blade as it is pulled or pushed over surfaces.

Many implements are also vulnerable to producing inconsistent results. For example, a hoe may upturn dirt 3″ to 5″ in one place and only 1″ to 2″ in another. Or the tines on a rake may dig into the soil a couple of inches in one place and may skip over the soil in others. Then again, it is commonplace for these same users of implements to want to manipulate their tools at times to perform additional tasks, such as softly pulling a rake atop soil for smoothing out or to use a hoe to skim the top of the soil for weeding small sprouts. Even a grader at times does not require the full weight of the implement atop soil or sand as the case may be. At one time or other, we have all tried to practice these various smoothing techniques with varying degrees of success. And for certain, expert landscapers use these various smoothing and feathering techniques on a daily basis.

It is difficult to use any of these tools and produce a consistent outcome, unless the user is particularly skilled in its use, and even then it is a time consuming task that requires much redo. Other factors that affect consistent results is that these tools are vulnerable to the user tiring, and may become difficult to use, unstable even, as they may bounce or bump over an even or uneven surface.

Even the use of a squeegee can be challenging at times, trying to drag its rubber blade over large windows, glass doors or flooring surfaces. Uneven draws of the squeegee are commonplace and at times tiring not knowing if pressure is being applied evenly.

One particular tool that partly addresses the difficulty of use of a manually pushed implement is the garden cultivator such as Earthway's, High Wheel Cultivator. This type of hand push garden cultivator is commonly used in a row garden setting. It has one wheel at the front middle of the device with two handles at the back. The operator walks behind the device and pushes it into the soil, which it breaks up with its plow attachment. It is designed to use specifically in a garden setting digging furrow between rows of crops. A tine type of tool may also be used to keep the soil disturbed and loose, and a hoe tool may be used to break up weed sprouts beginning to grow in the furrowed rows.

There are several problems with this type of hand cultivator, the first of which is its stability, or instability, as the case may be. Because the device has only one narrow contact point and one narrow wheel in the front middle of the device, it is up to the operator to maintain balance let alone push the implant. The operator must literally wrestle with the cultivator while simultaneously trying to maintain balance—wrestling with its side to side and up and down movement simultaneously. Second is control, or lack thereof, as the case may be, since it does not function from a stable platform having only two points of contact with the soil (ground). Third, the cultivator is unidirectional and is incapable of moving back and forth. Fourth, it lacks adaptability or versatility of use for any other applications as it is specifically designed only for a row garden.

The difficulty of use of all of these prior art manually pushed or pulled implements is directly related to the lack of being able to provide proper pressure, or leverage as the case may be. This is regardless of whether the implement is being used for everyday applications, or more unconventional applications such as feathering, or evenly hoeing by gauging the depth of the implement. In any of application, everyday or unconventional, the only solution might be the use of a motorized tractor, plow or such. Obviously the physical restrictions, substantial space requirements, environmental concerns, and high costs, would make the motorized approach impractical for most gardens and backyards.

### SUMMARY OF THE INVENTION

In one aspect, an outboard stabilizing system (OSS), includes a stabilizer bar with first and second outboard extensions each with a wheel mounted thereon; and a hand tool secured to the stabilizer bar, wherein a length of the two outboard extensions is determined based on the hand tool.

Implementations of the above aspect may include one or more of the following. The OSS assembly can be a system of rods or brackets in frontal or outboard location from the head of the tool that creates the stabilizing contact point to the working surface that in turn is the fulcrum of the leverage point. This assembly creates side to side stability and open up a multitude of versatile uses and applications for even inexperienced users. Another implementation of the outboard stabilizing system (OSS) can include a hand tool; and a stabilizer bar with first and second outboard extensions each with a wheel mounted thereon, wherein the stabilizer bar is bolted onto a bracket on the hand tool, bolted onto an external keeper on a hand tool, mounted through eyelets on brackets mounted atop or along the sides of a hand tool, snapped into u-shaped holders on a hand tool, or welded onto the hand tool; and wherein a width of the stabilizer bar is based on a width of the hand tool, and wherein a length of the two outboard extensions is determined based on the hand tool. The hand tool can be a rake, a squeegee, or a hoe, among others.

In one implementation, the outboard stabilizing system also provides a user with a unique leverage point at the contact point of the work surface. This allows the operator to raise or lower the working tool head by moving the handle up or down allowing the operator to create the desired contact between the working head and the surface being worked. This is particularly valuable when a user wants to create a predetermined depth (or height from and to the ground) of the implement's head. For example, it can be used to create a shallow depth on a hoe quickly or easily remove weed sprouts. The head of a broom can be used to quickly skim off larger particles and refuse and leave the underlying material if needed. This depth or height would be based on the desired job or the condition of the work surface. And the properly adjustability to create the desired height is easily accomplished by manipulating the leverage point created by the outboard stabilizing system (OSS). Furthermore, this OSS may be made with a number of adjustable features that allows it to move up and down or even reach further outboard or inboard as the case may be. This may be desirable based on the varying height of users or the size or type of use in which the implement will be employed. The OSS may further be adaptable to a myriad number of moving (or stabilizing) facilitators such as wheels, rollers, skids, rails and the like.

The number of hand tools that can benefit from the application and method of use that the preferred embodiment and its technology provide may be substantial. For example, it may include, but is not limited to: rakes, hoes, shovels, squeegees, sprayers, washers, scrapers, weed extractors, graders, forks, push brooms, magnet sweeper, and so on. Any hand tools that would benefit from stabilizations and that may or may not use leverage for an improved or more versatile performance would benefit.

The leverage device for hand tools of the preferred embodiment overcomes the problems associated with prior art. The preferred embodiment is a device and method developed to enhance the stability, workability, versatility, and functionality of garden, maintenance, landscape, construction and household hand tools. The preferred embodiment is made of a leverage stabilizing system comprising outboard wheels or rollers and in some cases rods, skids, brackets or blades.

The hand tool leverage device is designed to create a stable platform for the hand tool to operate. This stable platform immediately resolves the problem of instability of a singular contact point, or a narrow contact point as in the hand cultivator, of prior art. This is accomplished by creating one or more additional contact points in front of the working implement or tool, thus creating a stable platform from which the tool may operate.

With a stable platform the preferred embodiment uses this forward contact point as a means of leverage to work and manipulate the head of the tool. From the leverage point to the handle, the operator, by moving the handle of the tool up and down, can determine how much of the work head of the tool shall be in contact with the ground or surface in order to accomplish the desired outcome. This stabilized system may be used for common, everyday use, to more sophisticated applications success gauging the depth of a hoe when in use or smoothing and feathering the surface of soil, sand or the like.

The preferred embodiment also produces a remarkable ability to use a hand tool in a smooth, fluid motion. This is accomplished with its outboard stabilizing system consisting of the outboard rollers, wheels, or the like, thus providing a balanced, stabilized operation with the tool's head. This natural balance allows a smooth movement back and forth of the tool being used, which movement would otherwise be difficult or impractical at best. Unlike prior art the work head can efficiently and practically be used in both the forward and backward direction giving a greater range use of the tool. Likewise, it makes the task of many everyday operations much easier for the user with a more consistent outcome.

While simple rods or braces alone can create a desired leverage contact point for stability, it would be more desirable to use rollers or wheels as will be subsequently illustrated herein. With movable outboard points such as wheels, rollers and skids, the desirable back and forth movement of the tool is easier, faster and smoother to operate.

Implementations of the preferred embodiment can provide:
1) A stabilized hand tool;
2) A stabilized hand tool with a leverage point;
3) A hand tool with greater control for the user;
4) A hand tool that is easier to use and with better mobility;
5) A hand tools that increase the speed of use with superior results;
6) A versatile hand tool that broadens its uses;
7) A light weight device that is multi-functional;
8) A system of providing leverage to a hand tools in order to control and manipulate the tools head;
9) A system that provides the user with the ability to use a back and forth movement;
10) A system that is cost effective;
11) A system that may be adaptable to existing hand tools;
12) A hand tool that is extremely versatile with both large and small hand tools;
13) A hand tool with an outboard stabilizer that is adjustable in a lateral direction, “in and out”;
14) A hand tool with an outboard stabilizer that is adjustable in a vertical direction, “up and down”;
15) A hand tool that is adjustable in any number of commonly known methodologies.

Furthermore, it is an object of this application to illustrate the preferred embodiments and broadly state the methodologies that may be used in order to create stability, leverage, mobility, speed and ease of use of tools using the leverage device for hand tools.

### BRIEF DESCRIPTION OF THE DRAWINGS

FIG. 1a is a perspective view of one of the preferred embodiments of the preferred embodiment.

FIG. 1b is a perspective view of another preferred embodiment of the preferred embodiment.

FIG. 2a is a perspective view of the preferred embodiment attached to a hoe.

FIG. 2b is a side view of the preferred embodiment attached to a hoe, showing it in use.

FIG. 3a is a perspective view of the preferred embodiments of the preferred embodiment when attached to a rake.

FIG. 3b is a side view of the preferred embodiment attached to a rake, showing it in use.

FIG. 4 is a perspective view of a variation of the preferred embodiment as it may be used on a grader.

FIG. 5 is a perspective view of the preferred embodiment showing how it may be adjustable.

### DETAILED DESCRIPTION OF THE INVENTION

### A. Description of the Preferred Embodiment

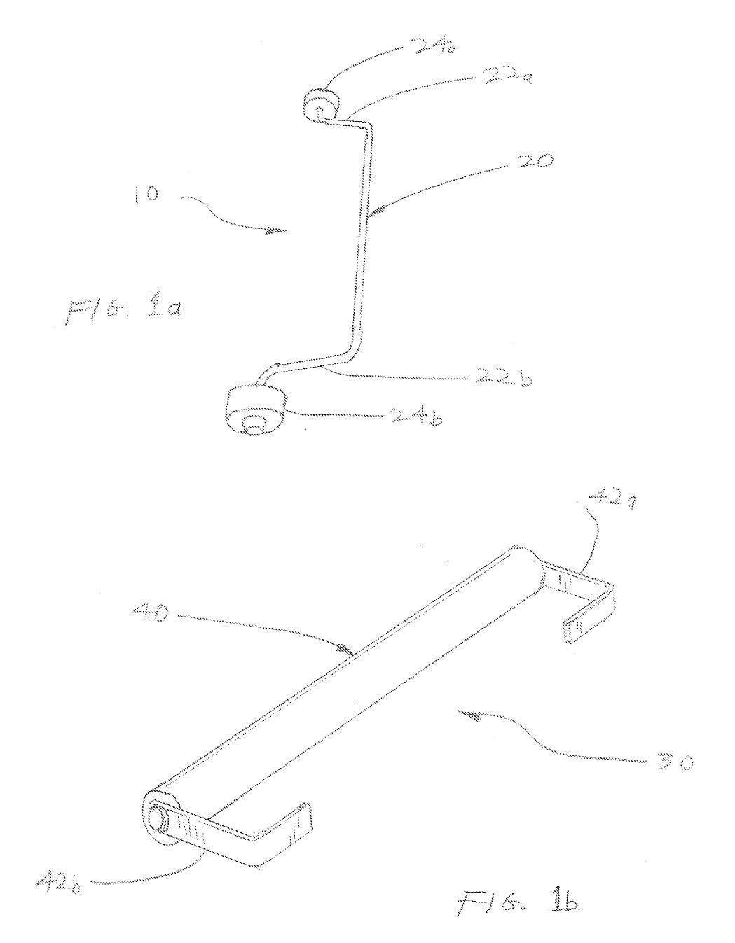

In FIG. 1a, an outboard stabilizing system (OSS) 10 is shown in an unattached disposition to more completely explain it purpose. OSS 10 consists of a stabilizer bar 20 with two outboard extensions 22a and 22b, which extensions have wheels 24a and 24b mounted at their ends. As illustrated in herein, the width of the stabilizer bar 20 would be determined based on the general width of the hand tools in which it would be mounted. Likewise the length of the two outboard extensions 22a and 22b may vary depending on the type of hand tool in which it will be mounted and the breadth and use of its tool. More specific lengths will be illustrated in the subsequent figures. Wheels 24a and 24b may also be mounted in an inward disposition on extensions 22a and 22b, providing they fulfill the desired purpose.

The two wheels 24a and 24b are used only as one possible form of rolling, sledding, or skidding device and instead of being wheels may be simple skids, such as miniature skis, curved rods, or any form of slide-able configuration. The wheels may be made of any suitable type of wheeled assembly and of any suitable material depending on the application, the desired quality, and so on. Skids, skis or other slide-able forms may be made of steel, plastic and the like and may come in any suitable configuration. Typically a skid or ski-form would have upturned outer ends in order to free slide (move) back and forth.

The stabilizer bar 20 may be mounted onto a hand tool in any number of means, some of which will be illustrated in subsequent drawings. These may consist of being bolted onto a bracket on the hand tool, bolted onto an external keeper on a hand tool, mounted through eyelets on brackets mounted atop or along the sides of a hand tool, snapped into u-shaped holders on a hand tool, welded onto the hand tool, and so on. There are also an abundance of adjustable means that may also be used in conjunction with the various types of mounts.

In FIG. 1b, the variation of the preferred embodiment, OSS 30 consists of a long stabilizer roller 40, mounted at the end of two outboard extensions 42a and 42b. In this illustration stabilizer roller 40 may be contain an axle or may be of sufficient rigidity to provide the desired performance without an axle. The means of connecting to the two outboard extensions 42a and 42b may be in any number of means providing the security and quality desired. Roller 40 may be in any number of diameters and quality standards suitable for the hand tool and quality desired. It may also be a series of rollers adjacent one another or spaced as may be desired.

As illustrated the two outboard extensions 42a and 42b are used to extend the outboard stabilizer roller 40 to a distance sufficiently far from the implemental tool component of a hand tool. This distance may vary according to needs and may be adjustable much like the OSS 10 in FIG. 1. The two outboard extensions 42a and 42b may be of any type of generally rigid material, metal, plastic or the like, in order to support stabilizer roller 40 in its outboard disposition when put in use and leverage is applied. The attachment of the two outboard extensions 42a and 42b to a hand tool may also be in any number of forms, permanent or adjustable, as described in FIG. 1.

### B. Description of the Preferred Embodiment Prepared for Use

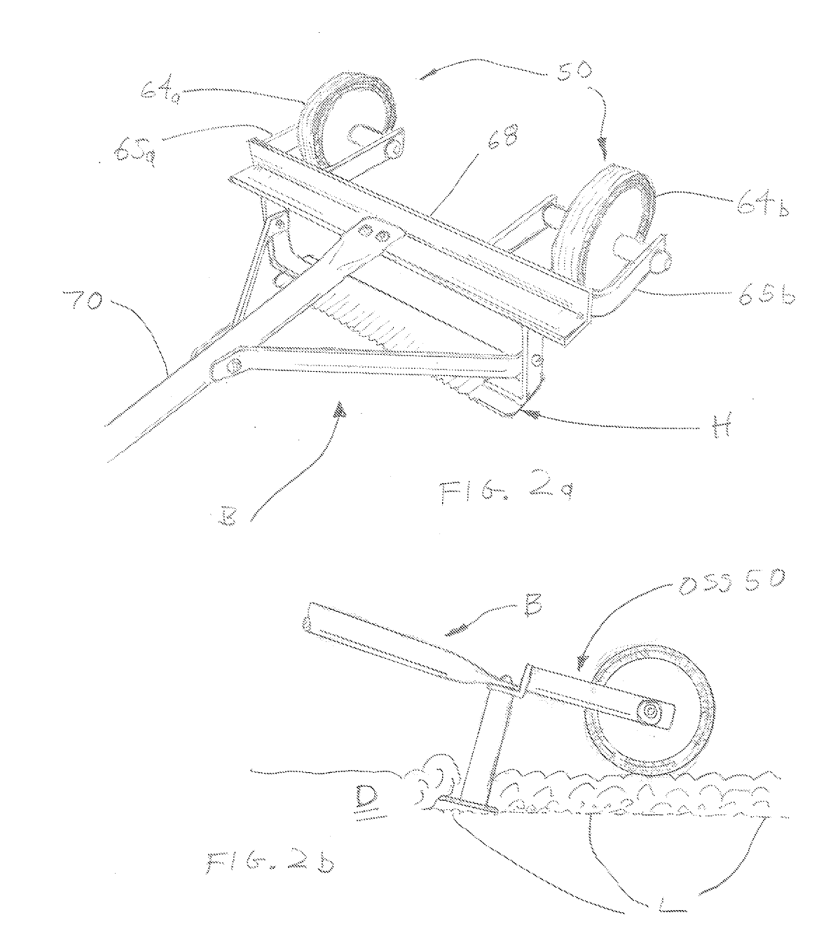

In FIG. 2a, the preferred embodiment 50, much like that of OSS 10 in FIG. 1a, but with two larger wheels 64a and 64b, attached by two large U-shaped brackets 65a and 65b, in turn said brackets are attached to cross member 68, which in turn is attached to handle 70 of hoe B. Head assembly H of hoe B is like any common variety of hoe used for upturning soil when preparing for planting, or as may be used for de-weeding and so on. As illustrated, OSS 50 is in an outboard location several inches behind hoe E. This distance may vary depending on the type or size of tool being used and the application. In most relatively common uses and applications, the distance would be about 4″ to 7″ out from the cross member 68.

In FIG. 2a hoe B with the preferred embodiment OSS 50 attached, is able to easily upturn dirt D and at a consistent depth shown as line L. With OSS 50 hoe B has several substantial advantages. First, it maintains an even drawing when the user (not shown) pulls on hoe E. In other words, one side will not dip down or rise up further than the other. Second, the depth of the head F of hoe E is consistent as it is pulled by the user. Third, the user saves energy by knowing that the proper depth is consistently reached and that rework will not be required, which is particularly important when hoeing larger gardens. Fourth, with the OSS 50 mounted outboard as illustrated, the user may feather dirt D afterward, thus helping level it out and perhaps eliminate the need to for the surface to be raked. Fifth, in concert with OSS 50 hoe B may be very easily used to in another application to skim off the surface and extract weed seedling and sprouts.

In this particular application with the use on a hoe, the type of OSS used, either with wheels as illustrated or like the preferred embodiment 30 in FIG. 1b, the outcome is feasible, but the larger wheels in OSS 50 make it easier.

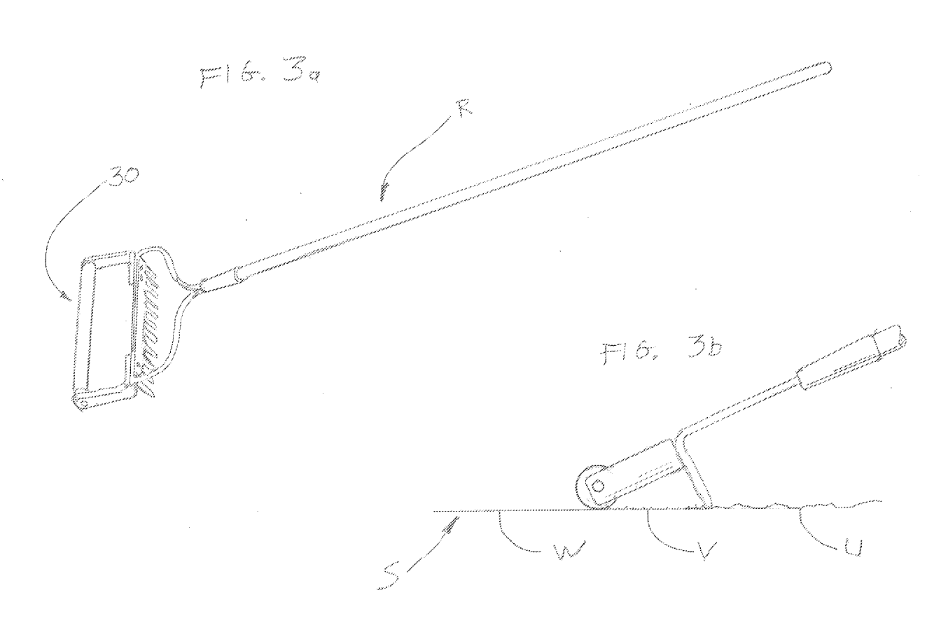

In FIG. 3a, the preferred embodiment 30 in FIG. 1b has been attached to a garden rake R. As illustrated, the two outboard extensions 42a and 42b have been attached to rake R by fasteners 46a and 46b, thus placing stabilizer roller 40 outboard (outward) from rake head H. As illustrated the distance between stabilizer roller 40 and rake head H may depend on the type of rake being used and the application. In most relatively common garden uses and applications with a rake, the distance would be about 3″ to 5″ outward from tines T in rake head H.

In FIG. 3a rake R with the preferred embodiment OSS 30 attached is able to rake a surface S with several substantial advantages. First, it maintains an even drawing when the user (not shown) pulls on rake R. In other words, one side will not dip down or rise up further than the other. Second, the ease of pulling on rake R is lessened preventing tiring by the user, which is particularly important when raking larger surfaces. Third, the use of OSS 30 with a rake also gives the user the unprecedented ability to push and pull the rake, thus greatly speeding up the intended process. Fourth, with the OSS 30 mounted the user may easily feather surface S, which is highly desirable in many applications. For example, dirt and gravel walkway, school grounds, a baseball infield, grass surfaces where it may be desired to pick up leaves and pine cones without interrupting or snagging the underlying grass. The means of attachment of OSS 30 to rake R may be in any number of configurations as previously disclosed with the only criteria being it is secure in place so that stabilizer roller 40 may serve as a leverage point.

While it may be acceptable to use an OSS with wheels such as the preferred embodiment 10 illustrated in FIG. 1a, there is another particularly unique advantage of using OSS 30 with roller 40 as illustrated in FIGS. 3a and 3b. As illustrated in FIG. 3b stabilizer roller 40 serves not only serves as a stabilizer or a leverage device during raking, it also provides a grading function that smoothes down surface S after the raking when using the pulling process. In FIG. 3b this is more precisely illustrated with the un-raked surface U in a jagged line, raked surface V in a slightly jagged line, and with raked and smoothed surface W with a smooth liner.

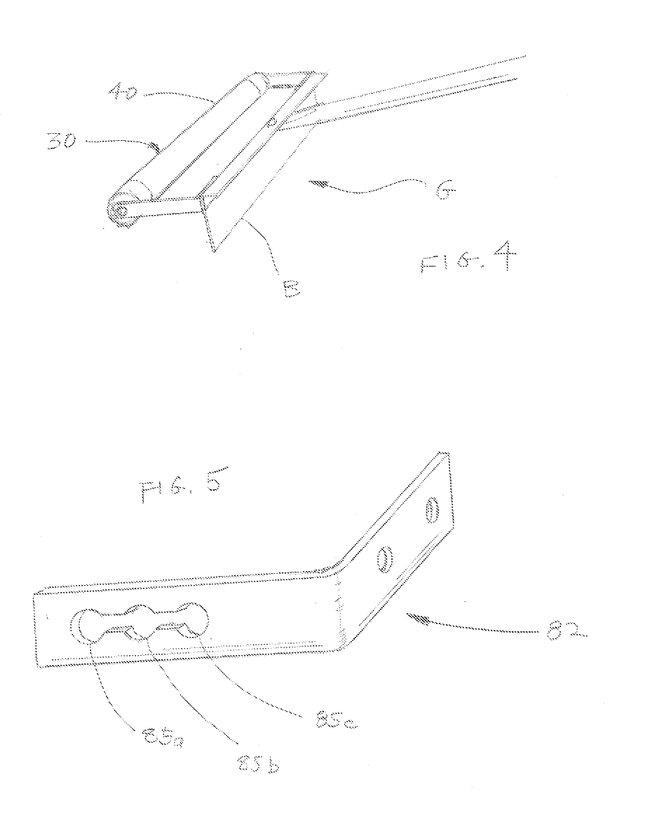

In FIG. 4 grader G has an OSS 30 much like that in FIG. 1b and as used on rake R in FIGS. 3a and 3b. Grader G has one single blade B that spans the grader's entire width and is used to level out dirt, sand, gravel and the like in places such as walkways, paths, playgrounds, sports fields and so on. Stabilizer roller 40 sets outboard of blade approximately 4″ to 7″ and provides, once again, the same unique features and benefits as previously described in FIGS. 2a and 2b and 3a and 3b. One particularly impressive outcome of using OSS 30 with grader G is that the quality of the smoothed surface is exceptionally even and smooth, virtually impossible to accomplish with any other form of hand tool without an OSS.

FIG. 5 is a perspective view of the preferred embodiment showing one of many methods of making it adjustable. The illustrated adjustable bracket 82 is much like that of bracket 42b in FIG. 1b, with the exception that it has keyed holes 85a, 85b and 85c that may be used to adjust the distance of an outboard stabilizer roller such as that of 40 in FIG. 1b. The system of pulling outward on a spring-loaded hub nut unit and then releasing it into one of the keyed holes for the desired distance from a hand tool's head, makes adjustment a simple process. Another common form of adjustment would be like that commonly used in lawnmowers to adjust the height from the ground.

No effort is going to be made to illustrate or list all of the types of adjustable phenomena that may be used with the preferred embodiment since the type of adjustability desired by a manufacturer of a hand tool of the preferred embodiment may be its own preferred method. However, it is noted that any form of adjustability of one form or another is specifically considered a useful feature falling under the scope of the preferred embodiment.

Likewise, another form of adjustability also falls under the scope of the invention revealed herein, which is the ability to move the outer stabilizer roller (or wheels as the case may be) up or down (as opposed to in and out as defined in the previous paragraph). Any number of forms of similar keyed holes, ratcheting systems, tongue and groove locking systems, and so on, may be used to adjust the height of the outboard wheels or stabilizer roller for a particular job. It goes without saying that the teachings herein are sufficient to define the inventive subject matter and that further drawings to illustrate a wheel or roller moving up and down, or in and out are not required in order to declare the inventive subject matter.

### E. Variations

The spirit of the preferred embodiment provides a breadth of scope that includes all methods of making and using it. Regardless of whether an OSS is attached to an existing hand tool or the hand tool comes with the OSS attached, it is considered under the scope of the preferred embodiment. Any variation on the theme and methodology of accomplishing the same that are not described herein would be considered under the scope of the preferred embodiment.

For further clarification, the reader can easily see and contemplate the desirability of the Outboard Stabilizing System and it functionally as a leverage device may be applied to virtually any type of hand tool, in particular any that require a pushing or pulling action such as those previous described, for example, squeegees, hoes, screeds, cultivators, all forms of rakes, even some shovels, and so on.

What is claimed is:

1. An outboard stabilizing system (OSS), comprising:
a stabilizer bar with first and second outboard extensions each with a wheel mounted thereon; and
a hand tool secured to the stabilizer bar, wherein a length of the two outboard extensions is determined based on the hand tool, wherein the stabilizer bar provides a stabilizing contact point to the working surface that in turn is a fulcrum of a leverage point providing side to side stability.

2. The system of claim 1, wherein the wheels are mounted in an inward disposition or an outward disposition on the extensions.

3. The system of claim 1, wherein the wheels comprise rolling wheels, sledding wheels, skidding wheels.

4. The system of claim 1, wherein the stabilizer bar comprises a roller.

5. The system of claim 1, wherein the wheels are selected from the group consisting of skis, curved rods, and slideable arms.

6. The system of claim 1, wherein the stabilizer bar is bolted onto a bracket on the hand tool, bolted onto an external keeper on a hand tool, mounted through eyelets on brackets mounted atop or along the sides of a hand tool, snapped into u-shaped holders on a hand tool, or welded onto the hand tool.

7. The system of claim 1, wherein the stabilizer forms a cross member, further comprising:
a hoe having a handle coupled to the cross member;
inside extensions in combination with the outboard extensions to form at least one U-shaped bracket mounted to the cross member, wherein the wheels are secured to the U-shaped bracket.

8. The system of claim 7, wherein the cross member is located several inches behind the hoe.

9. The system of claim 7, wherein the wheels contact the ground while the hoe contacts are underground during operation.

10. The system of claim 1, further comprising:
a rake having a handle coupled to the stabilizer bar; and
a roller rotatably coupled to the stabilizer bar.

11. The system of claim 10, wherein the outboard extensions are attached to the rake by fasteners to place a stabilizer roller outward from a rake head.

12. The system of claim 11, wherein the stabilizer roller comprises a leverage device during raking and a grader that smooths ground surface after raking when using a pulling process.

13. The system of claim 12, wherein the grader has one single blade that spans the grader's entire width to level out dirt, sand, gravel and wherein the stabilizer roller sets outboard of the single blade approximately 4 inches to 7 inches.

14. The system of claim 1, comprising an adjustable bracket with keyed holes to adjust the distance of an outboard stabilizer roller.

15. The system claim 1, comprising a spring-loaded hub nut unit for pulling outward and subsequently releasing the hub nut unit into one of the keyed holes for a desired distance.

16. A method to stabilize a hand tool during operation, comprising
a stabilizer bar with first and second outboard extensions each with a wheel mounted thereon; and
a hand tool to mount the stabilizer bar, wherein a length of the two outboard extensions is determined based on the hand tool.

17. The method of claim 16, wherein the stabilizer forms a cross member, comprising
attaching the stabilizer bar to a hoe having a handle coupled to the cross member;
providing inside extensions in combination with the outboard extensions to form U-shaped brackets mounted to the cross member; and
securing the wheels to the U-shaped brackets.

18. The method of claim 16, comprising
stabilizing a rake by securing a rake handle to the stabilizer bar; and providing a roller on the stabilizer bar; and
grading and smoothing ground surface with the roller after raking when using a pulling process.

19. The method of claim 16, comprising a height of an outboard stabilizer roller with an adjustable bracket and keyed holes.

20. The method of claim 19, comprising providing a user with a unique leverage point at the contact point of the work surface with an ability to raise or lower a working tool head to create a desired contact between the working head and ground to create a predetermined depth with the tool head.
